(19) United States
(12) Patent Application Publication
(10) Pub. No.: US 2012/0204114 A1
(43) Pub. Date: Aug. 9, 2012

(54) MOBILE APPLICATION FRAMEWORK

(75) Inventors: Nicholas Jessen, Eagle Mountain, UT (US); Jonathan Virgin, Eagle Mountain, UT (US); Matthew Good, Draper, UT (US)

(73) Assignee: OSCIX, LLC, Lehi, UT (US)

(21) Appl. No.: 13/369,180

(22) Filed: Feb. 8, 2012

Related U.S. Application Data
(60) Provisional application No. 61/440,752, filed on Feb. 8, 2011.

(51) Int. Cl. G06F 3/048

(52) U.S. Cl. 715/738

(57) ABSTRACT

For providing a mobile application framework, a memory stores a current browser-renderable code on electronic device. A synchronize module synchronizes the current browser-renderable code with available browser-renderable code when the electronic devices connected to a network. A display module displays the current browser-renderable code.

### CROSS-REFERENCE TO RELATED APPLICATIONS

This application claims priority to U.S. Provisional Patent Application No. 61/440,752 entitled “MOBILE APPLICATION FRAMEWORK” and filed on Feb. 8, 2011 for Nicholas Jensen et al., which is incorporated herein by reference.

### BACKGROUND

1. Field

The subject matter disclosed herein relates to mobile applications and more particularly relates to a mobile application framework.

2. Description of the Related Art

Mobile devices often use custom applications. It is advantageous for custom applications to be easy to create and update.

### BRIEF SUMMARY

A program product for a mobile application framework is disclosed. A storage device stores machine readable code executable by a processor. The machine readable code stores current browser-renderable code on an electronic device. The machine readable code further synchronizes the current browser-renderable code with available browser-renderable code when the electronic device is connected to a network. In addition, the machine readable code displays the current browser-renderable code. A method performing the functions of the program product is also disclosed.

### BRIEF DESCRIPTION OF THE DRAWINGS

A description of the embodiments of the invention will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a mobile system;

FIG. 2 is a schematic block diagram illustrating one embodiment of an electronic device;

FIG. 3 is a schematic block diagram illustrating one embodiment of a memory;

FIG. 4 is a schematic block diagram illustrating one embodiment of a mobile application apparatus;

FIG. 5 is a schematic flow chart diagram illustrating one embodiment of a synchronization method; and

FIG. 6 is a schematic flow chart diagram illustrating one embodiment of a display method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more storage devices storing machine readable code. The machine readable code may be referred to as code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in machine readable code and/or software for execution by various types of processors. An identified module of machine readable code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of machine readable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more storage devices.

Any combination of one or more machine readable medium may be utilized. The machine readable storage medium may be a machine readable signal medium or a storage device. The machine readable medium may be a storage device storing the machine readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A machine readable signal medium may include a propagated data signal with machine readable code embodied therein, for example, in baseband or as part of a carrier wave. Such a propagated signal may take any of a variety of forms, including, but not limited to, electro-magnetic, optical, or any suitable combination thereof. A machine readable signal medium may be any storage device that is not a computer readable storage medium and that can communicate, propagate, or transport a program for use by or in connection with an instruction execution system, apparatus, or device. Machine readable code embodied on a storage device may be transmitted using any appropriate medium, including but not limited to wireless, wireline, optical fiber cable, Radio Frequency (RF), etc., or any suitable combination of the foregoing.

Machine readable code for carrying out operations for embodiments may be written in any combination of one or more programming languages, including an object oriented programming language such as Java, Smalltalk, C++ or the like and conventional procedural programming languages, such as the “C” programming language or similar programming languages. The machine readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by machine readable code. These machine readable code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The machine readable code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The machine readable code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and machine readable code.

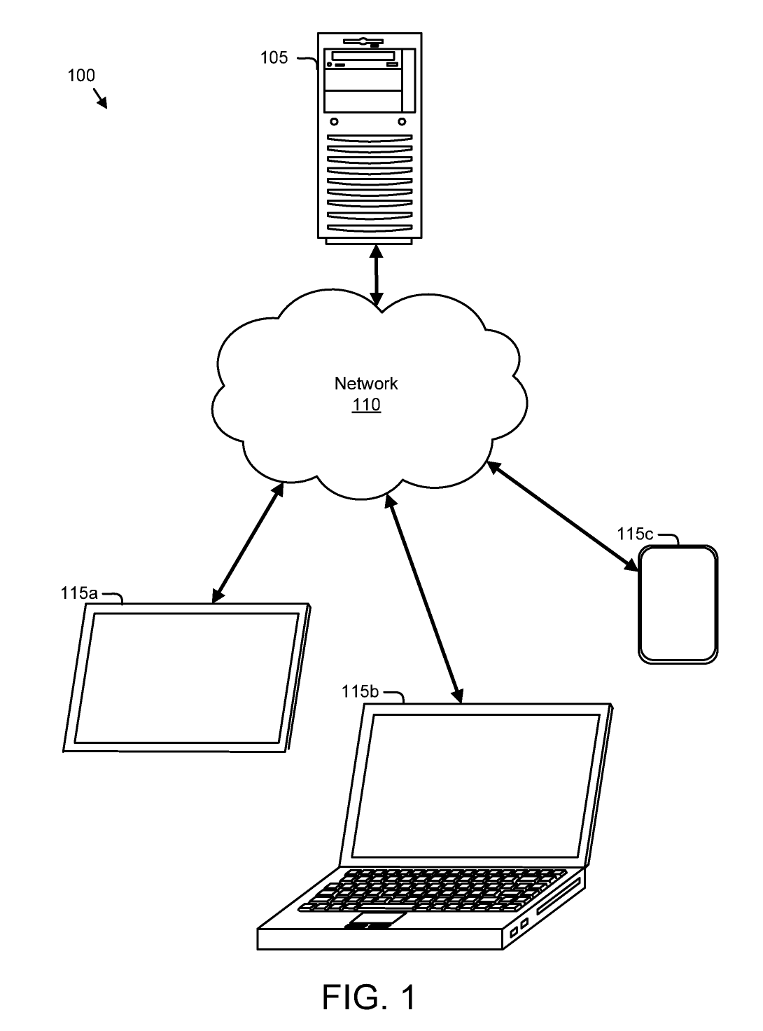

FIG. 1 is a schematic block diagram illustrating one embodiment of a mobile system 100. The system 100 may provide mobile applications to one or more electronic devices 115. The electronic devices 115 may include cellular telephones, notebook computers, personal digital assistants, tablet computers, and the like. An electronic device 115 may communicate with the server 105 over a network 110. In one embodiment, the network 110 is a cellular telephone network. Alternatively, the network 110 may be a wireless data network. In a certain embodiment, the network 110 is a wired network.

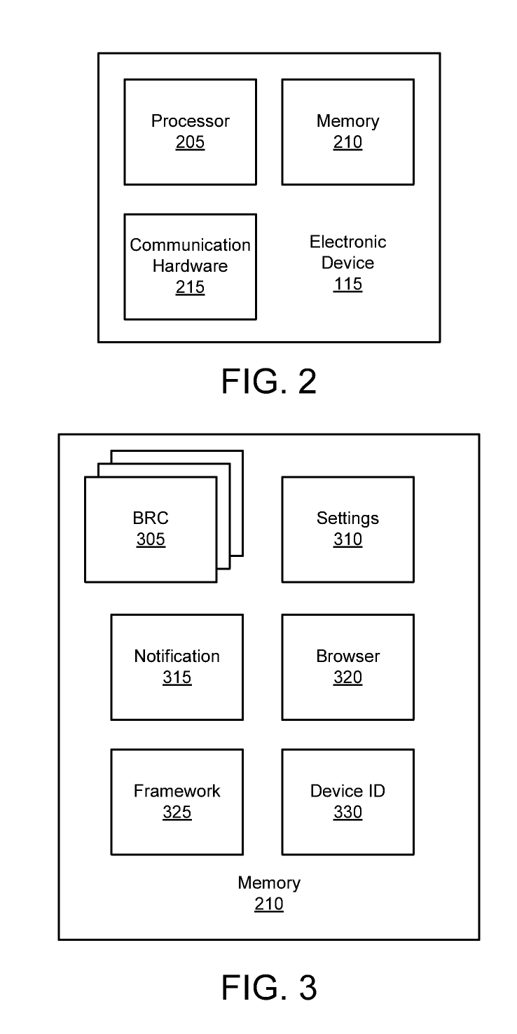

FIG. 2 is a schematic block diagram illustrating one embodiment of an electronic device 115. The electronic device 115 may be the electronic device 115 of FIG. 1. The description of the electronic device 115 refers to elements of FIG. 1, like numbers referring to like elements. The electronic device 115 includes a processor 205, a memory 210, and communication hardware 215.

The memory 210 may store machine-readable code. The machine-readable code is referred to hereafter as code. The processor 205 may execute the code. Responsive to the code, electronic device 115 may communicate with the user and/or other electronic devices 115 through the communication hardware 215. The communication hardware 215 may include but is not limited to a display, an input/output device, a wireless interface, a wired interface, and the like.

FIG. 3 is a schematic block diagram illustrating one embodiment of a memory 210. The memory 210 may be the memory 210 of FIG. 2. The description of the memory 210 refers to elements of FIGS. 1-2, like numbers referring to like elements. In one embodiment, the memory 210 may store browser-renderable code (BRC) 305, settings 310, a notification 315, a browser 320, a framework 325, and a device ID 330. The BRC 305 that are stored on the electronic device 115 may be referred to as current BRC. The BRC 305 that are stored on the server 105 may be referred to as available BRC.

In one embodiment, the framework 325 performs the functions of a mobile application. The framework 325 may be executable by the processor 205.

The BRC 305 may be HyperText Markup Language (HTML) code, eXtensible Markup Language (XML) code, Java Script Code, HTML5 code, Cascading Style Sheet (CSS) code, image code, combinations thereof, or the like. The BRC 305 may be stored in a file system of an operating system, organized as an array of linked objects, stored in a flat file, or the like. Although the memory 210 may store a plurality of BRC 305, for simplicity a single BRC 305 is discussed.

The settings 310 may include a specified sync time interval, an opt-in flag, and the like. The specified sync time interval may specify a time interval that must elapse before synchronizing the current BRC 305. For example, if the specified sync time interval is 30 minutes, the framework 325 may attempt to synchronize the current BRC 305 after 30 minutes have elapsed. In one embodiment, the opt-in flag is set to indicate that the user has agreed to allow the display of the current BRC 305 in response to the notification 315.

The memory 210 may store a plurality of notifications 315 although for simplicity a single notification 315 is shown. The notification 315 may be received from the server 105. Alternatively, the notification 315 may be generated by the framework 325. The notification 315 may include a hierarchical organization of the BRC 305. The hierarchical organization may specify the order in which the BRC 305 are displayed, dependencies between the BRC 305, conditional tests, verification data, formatting data, prompts data, and the like. The notification 315 may also include a specified display time, a specified display start time interval, a specified display end time interval, a specified display end time, and the like.

The specified display time may indicate a time for the framework 325 to display the current BRC 305. In one embodiment, the specified display time is a time of the time zone of the electronic device 115. In an alternate embodiment, the specified display time is an absolute time.

The specified display start time interval may specify a time interval after the specified display time during which the current BRC 305 may be displayed. The specified display end time may specify a time interval before the specified display time during which the current BRC 305 is allowed to be displayed.

The browser 320 may render the current BRC 305. In one embodiment, the browser 320 is executed by the framework 325 as an object.

The device identifier 330 may identify the electronic device 115. Alternatively, the device identifier 330 may identify all electronic devices of a specified account. In one embodiment, the device identifier 330 is a hash of an identification string for the electronic device 115. In one embodiment, the device identifier 330 is registered on a remote server such as the server 105 of FIG. 1.

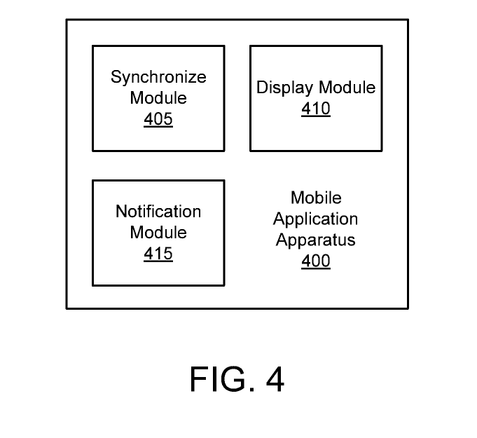

FIG. 4 is a schematic block diagram illustrating one embodiment of a mobile application apparatus 400. The apparatus 400 may be embodied in the framework 325 of FIG. 3. The description of the apparatus 400 refers to elements of FIGS. 1-3, like numbers referring to like elements. The apparatus 400 includes a synchronize module 405, a display module 410, and a notification module 415. The synchronize module 405, display module 410, and notification module 415, may comprise code stored in the memory 210 and executed by the processor 205.

The notification module 415 initiates displaying the current BRC 305 in response to a notification 315. The display module 410 displays the current BRC 305. In one embodiment, the display module 410 executes the browser 320 as an object to display the current BRC 305.

The memory 210 may store the BRC 305 on the electronic device 115. The synchronize module 405 may synchronize the current BRC 305 with available BRC 305 when the electronic device 115 is connected to the network 110.

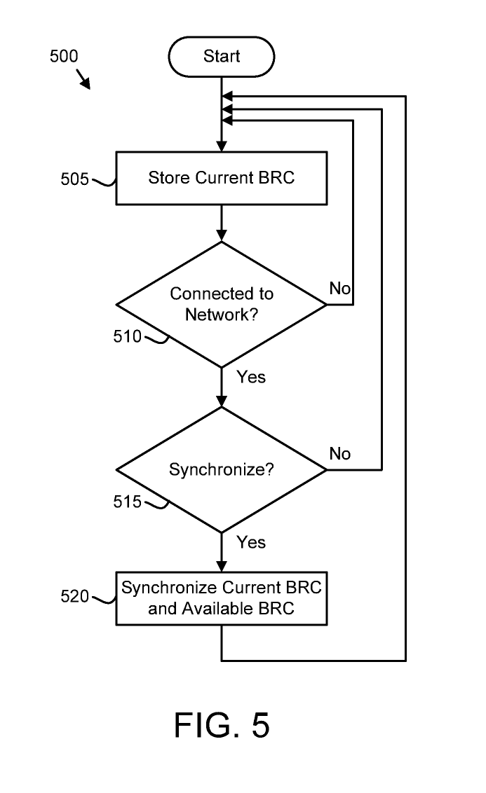

FIG. 5 is a schematic flow chart diagram illustrating one embodiment of a synchronization method 500. The method 500 performs the functions of the system and apparatus of FIGS. 1-4. The description of the method 500 refers to elements of FIGS. 1-4, like numbers referring to like elements. In one embodiment, the method 500 is performed by code stored in the memory 210 and executed by the processor 205.

The method 500 starts and in one embodiment, the memory 210 stores 505 the current BRC 305. The synchronize module 405 may determine 510 if the electronic device 115 is connected to the network 110. If the electronic device 115 is not connected to the network 110, the memory 210 may continue to store 505 the current BRC 305.

If the synchronize module 405 determines 510 that the electronic devices connected to the network 110, the synchronize module 405 may determine 515 whether to synchronize the current BRC 305. In one embodiment, the synchronize module 405 determines 515 to synchronize the current BRC 305 after the specified sync time interval has elapsed. In an alternate embodiment, the synchronize module 405 may determine 515 to synchronize the current BRC 305 each time the electronic device 115 is initially connected to the network 110. In a certain embodiment, the synchronize module 405 determines 515 to synchronize the current BRC 305 in response to a message from the server 105. Alternatively, the synchronize module 405 may determine 515 to synchronize the current BRC 305 in response to a user command.

In one embodiment, the server 105 receives the available BRC 305 as HyperText Markup Language (HTML) code. The server 105 may retrieve the BRC 305 using a URL. The server 105 may strip all HTML tags and data except an article. The article may be text, video, audio, an article URL, or combinations thereof. The server 105 may further strip a title from the BRC 305.

In one embodiment, the server 105 adds new content to the BRC 305. The new content may be links allowing a user to share the BRC 305, retrieve an original article, print the article, or the like. The server 105 may add display code that displays a specified theme or look. In one embodiment, the display code is JavaScript code. The server 105 may communicate the BRC 305 with new content to the electronic device 115.

In one embodiment, the synchronization module 405 monitors a Really Simple Syndication (RSS) feed. For example, the synchronization module 405 may request an RSS feed using a Universal Resource Locator (URL) and/or an application identifier.

If the synchronize module 405 determines 515 not to synchronize the current BRC 305, the memory 210 continues to store 505 the current BRC 305. If the synchronize module 405 determines 515 to synchronize the current BRC 305, the synchronize module 405 synchronizes 520 the current BRC 305 with the available BRC 305 stored on the server 105 and continues to store 505 the synchronized BRC 305.

In one embodiment, the synchronize module 405 receives an RSS feed. The synchronize module 405 may store the RSS feed. The synchronization module 405 may further parse at least one article and at least one image from the RSS feed. The article may be a text file, a URL, or the like. The image may be an image file, a video file, a URL, an audio file, or the like.

In one embodiment, the synchronize module 405 converts the at least one article and at least one image into a JavaScript Object Notation (JSON) format. The JSON format may be compatible with RFC 4627 as of Feb. 8, 2012. The data in the JSON format may be stored. In one embodiment, data in the JSON format is cached indexed by a Secure Hash Algorithm hash of the RSS URL. The data in the JSON format may be stored for a specified time interval.

The synchronize module 405 may synchronize 520 all of available BRC 305 to the electronic device 115. Alternatively, the synchronize module 405 may synchronize 520 only each available BRC 305 that includes the device identifier 330. The device identifier 330 may be stored in a list appended to each available BRC 305. Thus the synchronize module 405 may only download available BRC 305 targeted to the device identifier 330, allowing the download of available BRC 305 to be restricted to subscribers, users requesting a specified BRC 305, and the like.

In one embodiment, the synchronize module 405 compares a time stamp of the current BRC 305 with a time stamp of the available BRC 305. If the timestamp of the available BRC 305 is later than the timestamp of the current BRC 305, the synchronize module 405 may download the available BRC 305 to overwrite the current BRC 305.

In one embodiment, the synchronize module 405 compares a version number of the current BRC 305 with a version number of the available BRC 305. If the version number of the available BRC 305 indicates a later version, the synchronize module may download the available BRC to overwrite the current BRC 305.

By automatically synchronizing the current BRC 305, the synchronize module 405 performs a function that is impractical if not impossible for a human to perform. The automatic synchronization can assure that the electronic device 115 has the most recent practically available BRC 305. Thus, for example, when a user begins to use the framework 325 and BRC 305 with the browser, the electronic device 115 executes the recent available BRC 305, even if the electronic device 115 is not connected to the network 110 at the time of use. The user need not track or manage update versions, or have an active network connection.

In one embodiment, the framework 325 maintains a list of needed BRC 305. The synchronize module 405 may download the needed BRC 305 from the server 105 if the needed BRC 305 is not included in the current BRC 305. In one embodiment, a notification 315 may indicate one or more needed BRC 305.

In one embodiment, the server 105 downloads the available BRC 305 to the memory 210. Alternatively, the server 105 may update the list of needed BRC 305. The electronic device 115 may request the needed BRC 305 from a server address of the server 105. The server 105 may download the BRC 305 to the electronic device 115.

In one embodiment, the synchronize module 405 synchronizes 520 the current BRC 305 as a background operation. The background operation may be a multi-threaded background operation spawning multiple threads.

The method 500 synchronizes 520 the current BRC 305 stored on the electronic device 115 with the available BRC 305 stored on the server 105 when the network connection is available.

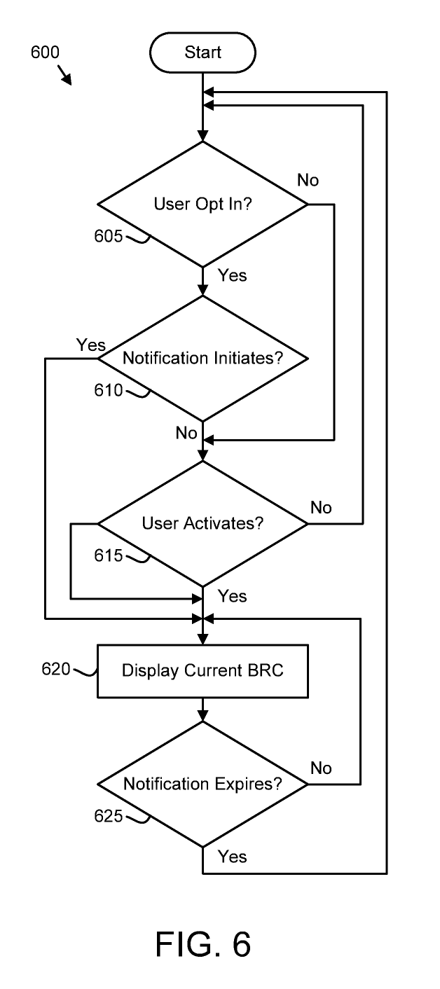

FIG. 6 is a schematic flow chart diagram illustrating one embodiment of a display method 600. The method 600 performs the functions of the system and apparatus of FIGS. 1-4. The description of the method 600 refers to elements of FIGS. 1-4, like numbers referring to like elements. In one embodiment, the method 600 is performed by code stored in the memory 210 and executed by the processor 205.

The method 600 starts, and in one embodiment the notification module 415 determines 605 if the user has opted in to displaying the current BRC 305. The notification module 415 may determine 605 that the user has opted in if the opt in flag is set. The user may respond to a prompt determining the opt-in flag status. If the user has not opted in, the notification module 415 continues to determine 605 if the user has opted in.

If the user has opted in, the notification module 415 further determines 610 if the notification 315 initiates display of the current BRC 305. The notification 315 may initiate displaying the current BRC 305 at the specified display time. In one embodiment, the notification 315 initiates displaying the current BRC 305 within the specified display start time interval of receipt of the notification 315. The notification 315 may expire after the specified display end time interval. Alternatively, the notification 315 may expire at the specified display end time.

If the notification module 415 determines 610 that the notification 315 initiates display, the display module 310 displays 620 the current BRC 305. The display module 310 performs a function that is impractical for the user, converting the BRC 305 into a useable image.

If the notification module 415 determines 610 that the notification 315 does not initiate display, the notification module 415 may determine 615 if the user activates display. In one embodiment, the user activates display through a user command. Alternatively, the user may activate display through another application.

If the user does not activate display, the notification module 415 continues to determine 605 if the user has opted in. If the notification module 415 determines 615 that the user activates display, the display module 310 displays 620 the current BRC 305.

The display module 310 may display 620 the current BRC 305 using the browser 320. The browser 320 may render the BRC 305 as is well known to those skilled in the art. In one embodiment, the display module 310 further communicates a response report. The display module 310 may communicate the response report to the server 105. In one embodiment, the server 105 may generate an analytical report from the response report.

In one embodiment, the display module 310 parses the BRC 305 and stores parsed elements of the BRC 305 in a custom object. The display module 310 may dynamically display 620 a screen image from the custom object. The display module 310 may also download and display 620 a mobile version of the BRC 305. The mobile version of the BRC 305 may be index with a hash of the mobile version and stored. In one embodiment, the mobile version is displayed 620 in response to a user command.

Method 500 synchronize 515 the current BRC 305 when the electronic device 115 is connected to the network 110. However, the method 600 allows the BRC 305 to be displayed 620 regardless of whether the electronic device 115 is connected to the network 110. Thus, the framework 325 may function as a Web-enabled mobile application even when the network 110 is not available. The BRC 305 may support providing the electronic device 115 with recent algorithms, data, media, and the like when the electronic device 115 is not connected to the network 110.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A program product comprising a storage device storing machine readable code executable by a processor to perform the operations of:
storing current browser-renderable code on an electronic device;
synchronizing the current browser-renderable code with available browser-renderable code when the electronic device is connected to a network; and
displaying the current browser-renderable code.

2. The program product of claim 1, wherein the current browser-renderable code is displayed when the electronic device is not connected to the network.

3. The program product of claim 1, wherein the current browser-renderable code is synchronized after a specified sync time internal.

4. The program product of claim 1, wherein the current browser-renderable code is synchronized in response to receiving a message.

5. The program product of claim 1, wherein first available browser-renderable code is synchronized to the electronic device if the first available browser-renderable code comprises a device identifier for the electronic device.

6. The program product of claim 5, wherein the device identifier is a hash of an identification string.

7. The program product of claim 5, wherein the device identifier is registered on a remote server.

8. The program product of claim 1, wherein the current browser-renderable code is displayed in response to a notification.

9. The program product of claim 8, wherein the notification initiates displaying the current browser-renderable code at a specified display time.

10. The program product of claim 8, wherein the notification initiates displaying the current browser-renderable code within a specified display start time interval of receipt of the notification.

11. The program product of claim 8, wherein the notification expires after a specified display end time interval.

12. The program product of claim 8, wherein the notification expires at a specified display end time.

13. The program product of claim 8, wherein the notification only initiates displaying the current browser-renderable code if a user opts in.

14. The program product of claim 1, wherein each browser-renderable code comprises code selected from the group consisting of HyperText Markup Language (HTML) code, eXtensible Markup Language (XML) code, Java Script Code, HTML5 code, Cascading Style Sheet (CSS) code, and image code.

15. The program product of claim 1, wherein the synchronizing is performed as a background operation.

16. The program product of claim 15, wherein the background operation is a multi-threaded background operation spawning multiple threads.

17. The program product of claim 1, the operations further comprising communicating a response report.

18. The program product of claim 1, wherein the browser-renderable code is displayed by a browser.

19. The program product of claim 18, wherein the browser is executed as an object.

20. A method for providing a mobile application framework comprising:
storing current browser-renderable code on an electronic device;
synchronizing the current browser-renderable code with available browser-renderable code when the electronic device is connected to a network; and
displaying the current browser-renderable code.
